(19) United States
(12) Patent Application Publication
(10) Pub. No.: US 2013/0291964 A1
(43) Pub. Date: Nov. 7, 2013

(54) PROPORTIONAL NORMALLY CLOSED PILOT PRESSURE CONTROL VALVE

(71) Applicant: Parker-Hannifin Corporation, Cleveland, OH (US)

(72) Inventors: William F Guse, JR., Glen Ellyn, IL (US); Clyde Bennett Stevens, Buffalo Grove, IL (US); Eric Schisler, St. Charles, IL (US)

(21) Appl. No.: 13/861,179

(22) Filed: Apr. 11, 2013

Related U.S. Application Data
(60) Provisional application No. 61/622,624, filed on Apr. 11, 2012.

(51) Int. Cl. G05D 16/10

(52) U.S. Cl. CPC G05D 16/10
USPC 137/489

(57) ABSTRACT

A proportional pressure control valve includes a cage housing and has an inlet, a relief outlet, and a control outlet. A relief poppet provides a proportional relief to the valve. A sleeve is received in a central bore of the cage housing. The sleeve has a fluid inlet fluidly connected to the inlet of the cage housing and has a fluid outlet fluidly connected to the relief outlet and the control outlet of the cage housing. A control piston is received in a central bore of the sleeve and is axially moveable between first and second positions therein. The control piston is configured to restrict flow through the outlet of the sleeve when the control piston is in the second position, and wherein the control piston is biased towards the first position.

### RELATED APPLICATIONS

This application claims the benefit of U.S. Provisional Application No. 61/622,624 filed Apr. 11, 2012, which is hereby incorporated herein by reference.

### FIELD OF INVENTION

The present invention relates generally to a pressure control valve with a means to regulate flow to the valve and to a connected hydraulic circuit, and more particularly to act as a proportional pressure reducing valve.

### BACKGROUND

Conventional cartridge type proportional relief valves are available in the industry. In some cases these are pilot sections incorporated into a single valve assembly or they are used to control individual valves or pump pressure controls. They are limited to the amount of flow they can handle as the flow variation causes the pressure to vary and become unstable. A common method is to incorporate an orifice upstream of the relief valve to limit the flow to the relief to provide a pressure reducing function.

### SUMMARY OF INVENTION

While the conventional orifice does limit the flow, the changes in the pressure drop over the orifice still creates a variation in the flow over the relief valve which causes variations in the pressure used to pilot a pump load sense or pilot operated logic valve. In preferred embodiments, in contrast, the orifice is replaced with a pressure compensated flow control valve incorporated within the cartridge to fix the flow rate to the proportional pilot relief thus reducing the pressure variation due to flow.

According to one aspect of the invention, a proportional pressure control valve includes a cage housing extending along a central axis and having an inlet, a relief outlet, and a control outlet. A relief poppet is movable between a first position and a second position, the first position restricting flow from exiting the cage housing via the relief outlet and the second position allowing flow to exit the cage housing via the relief outlet to provide a proportional relief to the valve. A sleeve is received in a central bore of the cage housing, the sleeve having a fluid inlet fluidly connected to the inlet of the cage housing and having a fluid outlet fluidly connected to the relief outlet and the control outlet of the cage housing. A control piston is received in a central bore of the sleeve and axially moveable between first and second positions therein. The control piston is configured to restrict flow through the outlet of the sleeve when the control piston is in the second position. The control piston is biased towards the first position.

Optionally, the fluid outlet of the sleeve is in a sidewall of the sleeve.

Optionally, the cage housing includes a sidewall having a fluid outlet therein, wherein the fluid outlet of the cage housing is fluidly connected to the fluid outlet of the sleeve.

Optionally, the relief outlet of the valve is a plurality of slots on the outside of the cage housing.

Optionally, the relief poppet is biased towards the first position.

Optionally, a biasing force on the relief poppet is adjustable via a solenoid opposing a spring element providing the biasing force.

Optionally, the control piston and the inlet of the sleeve form an edge filter.

Optionally, the control piston further includes a central bore open at a first end to the central bore of the sleeve, and the central bore of the piston is fluidly connected to the sleeve inlet via multiple sense orifices.

According to another aspect of the invention, a proportional pressure control valve includes a cage housing extending along a central axis and defining an inlet at a first end thereof for directing fluid into the cage housing; an outlet through a plurality of slots on the outside of the cage housing providing a proportional relief to the valve; a pressure compensating flow control valve comprising a cylindrical sleeve and a piston positioned within the first end of the cage housing, the cylindrical sleeve having an opening at one end thereof and having an orifice in a cylindrical wall of the sleeve, the piston positioned within the sleeve and biased toward the open end of the sleeve by a spring, the piston configured to selectively open and close the orifice in the sleeve; and an orifice in the cage housing providing a fluid passageway from the outside of the cylindrical sleeve through the cage housing.

Optionally, the piston includes an edge filter.

Optionally, the piston includes a plurality of sense orifices.

The foregoing and other features of the invention are hereinafter described in greater detail with reference to the accompanying drawings.

### BRIEF DESCRIPTION OF THE DRAWINGS

FIG. 1 shows a schematic diagram of a hydraulic system having an exemplary proportional pressure control valve;

FIG. 2 shows a cross-sectional view of an exemplary proportional pressure control valve;

FIG. 3 shows a detailed view of the pressure compensated flow control;

FIG. 4 shows a cross-sectional view of another exemplary proportional pressure control valve;

FIG. 5 shows a detailed view of the pressure compensated flow control; and

FIG. 6 shows a detailed view of another pressure compensated flow control.

### DETAILED DESCRIPTION

Conventional valves utilize an orifice to provide a pressure reducing function. Exemplary embodiments of the present invention replace the orifice with a pressure compensated flow control valve incorporated within the cartridge to fix the flow rate to the proportional pilot relief thus reducing the pressure variation due to flow.

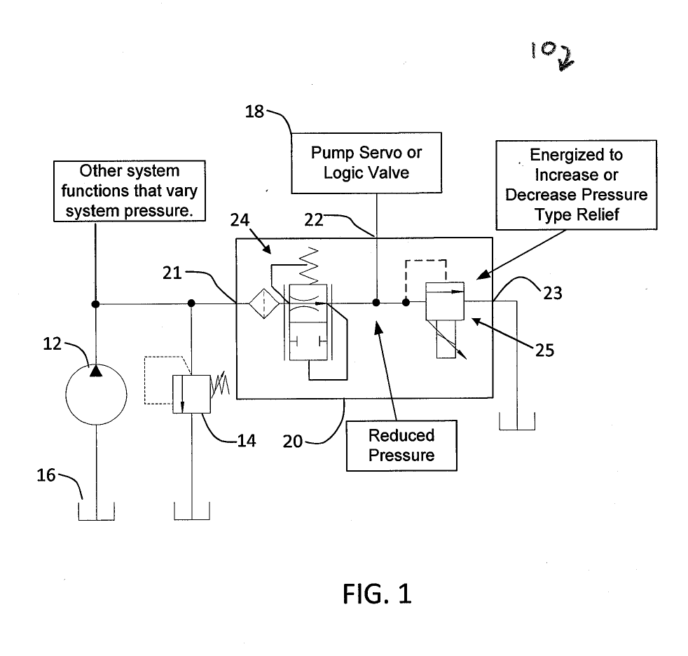

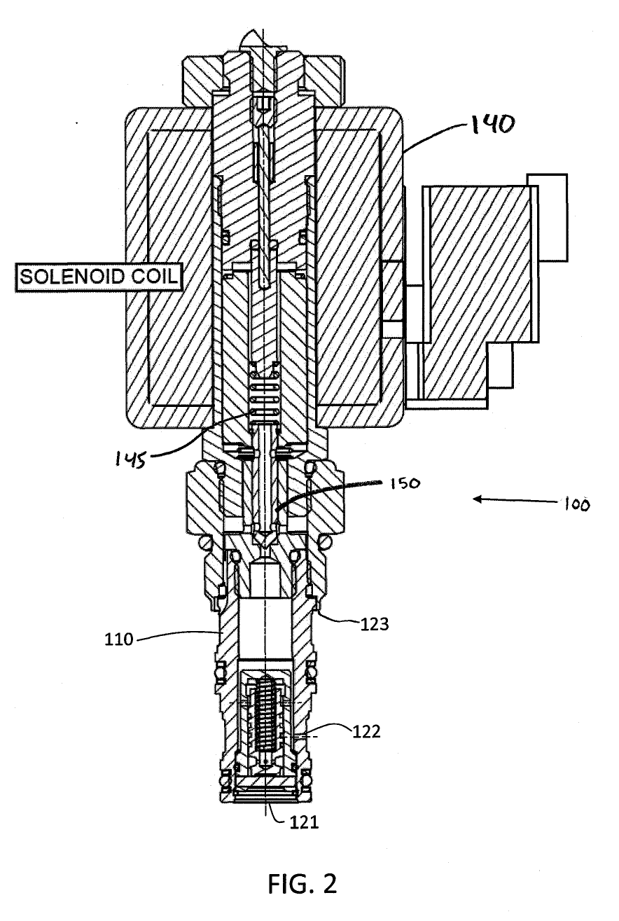

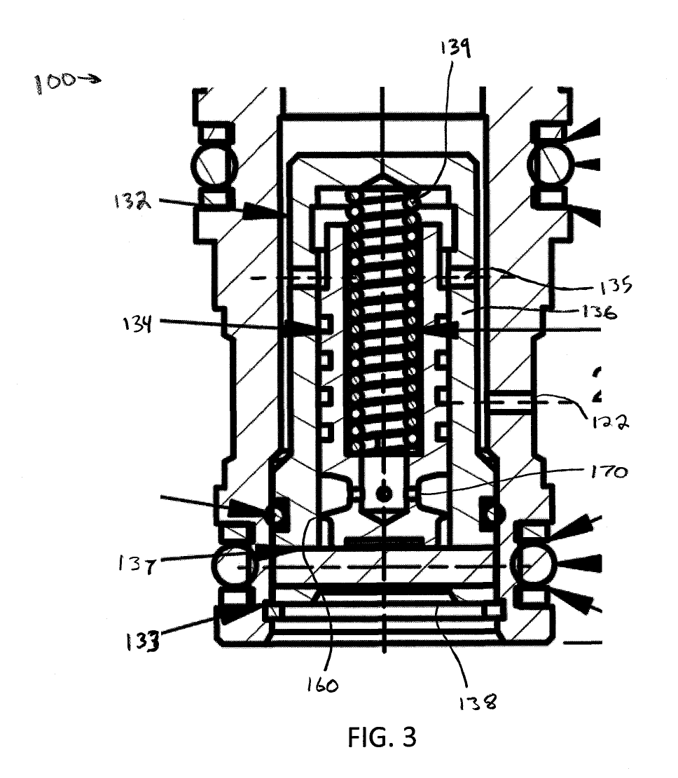

Referring first to FIG. 1, shown in schematic is a hydraulic system 10 including a pump 12, a pressure relief valve 14 which dumps fluid to tank 16 when the pressure rises above a predetermined amount, an operating section 18 (for example, a pump servo or logic valve), and a proportional pressure control valve 20. Flow from the pump 12 enters inlet/port 21 and passes through a pressure compensated flow control section (shown in more detail below, and in FIGS. 2 and 3.). The outlet of the pressure compensated flow control section 24 is connected out through control outlet/port 22. Alternatively, flow above a predetermined pressure may flow out through the proportional relief valve section 25 to relief outlet/port 23.

The pressure compensated flow control section 24 maintains the flow rate to the relief valve section 25 so that changes in the inlet/port 21 pressure due to variations in system working pressure do not affect the pressure at control outlet/port 22.

Turning now to FIGS. 2 and 3, the proportional pressure control valve 100 includes a cage housing 110 extending along a central axis and has an inlet 121 at a first end thereof for directing fluid into the cage housing 110, and has a control outlet/orifice 122 and a relief outlet/port 123. The relief outlet/port 123 may be through a plurality of slots on the outside of the cage housing and provides a proportional relief to the valve 100.

A pressure compensating flow control valve section 130 may include a cylindrical sleeve 132 and a control piston 134 received within a central bore of the cage housing 110 and positioned within the first end of the cage housing 110. The sleeve 132 may be retained by, for example, retaining ring 133, and the control piston 134 may be retained by, for example, pin 137. The cylindrical sleeve 132 may have a fluid inlet/opening 138 at one end thereof and may have one or more control holes 135 in a cylindrical wall 136 of the sleeve. The fluid inlet 138 is fluidly connected to the inlet 121 of the cage housing. The one or more control holes 135 are fluidly connected to the relief inlet and the control outlet 122 of the cage housing.

The control piston 134 may be received in a central bore of the sleeve 132 and axially moveable between first and second positions therein. The control piston 134 is biased toward the open end of the sleeve by a spring element 139. The piston 134 is configured to restrict flow through the outlet of the sleeve 132 when the control piston 134 is in the second position. Therefore, the control piston 134 is configured to selectively open and close the control holes 135 in the sleeve 132.

The outlet/orifice 122 in the cage housing 110 provides a fluid passageway from the outside of the cylindrical sleeve 132 through the cage housing 110.

A relief poppet 150 is movable between a first position and a second position, the first position restricting flow from exiting the cage housing 110 via the relief outlet 123 and the second position allowing flow to exit the cage housing 110 via the relief outlet 123 to provide a proportional relief to the valve.

The proportional relief, as shown in FIGS. 2 and 3, is normally closed and is pre-set to a maximum desired pressure. The normally closed configuration is used for illustrative purposes only, and it will be understood that embodiments of the invention will also work with a normally open relief type. In any case, current applied to the coil in solenoid 140 causes a solenoid force to oppose the internal spring element 145 and reduces the set pressure. Increasing current to the solenoid coil proportionally decreases the pressure at control outlet/orifice 122. The reduced pressure (outlet 122) defaults to high pressure when the coil is de-energized. For example, if the outlet 122 were connected to a pump, the default pressure setting could be set to fully stroke the servo piston or compensator. In another example, when combined with a logic element in a fan application, the default setting could provide full pressure to prevent bypassing the fan motor until energized.

When applied with a normally open type proportional relief, the pressure reducing function is maintained. However, with increasing current, the pressure at control outlet/orifice 122 will increase proportionally with the current. De-energizing the valve will reduce the outlet/orifice 122 pressure to near zero pressure.

As shown in FIG. 3, the control piston and the inlet of the sleeve may form an edge filter 160 used to provide primary protection of the sense orifice 170.

The sense orifice 170 of the flow control piston uses a series of multiple holes or sense orifices to offer secondary protection from being blocked. The multiple holes also provides a better level of orifice size control than a single large orifice that does not offer the same level of flexibility in sizing for the various potential flow requirements.

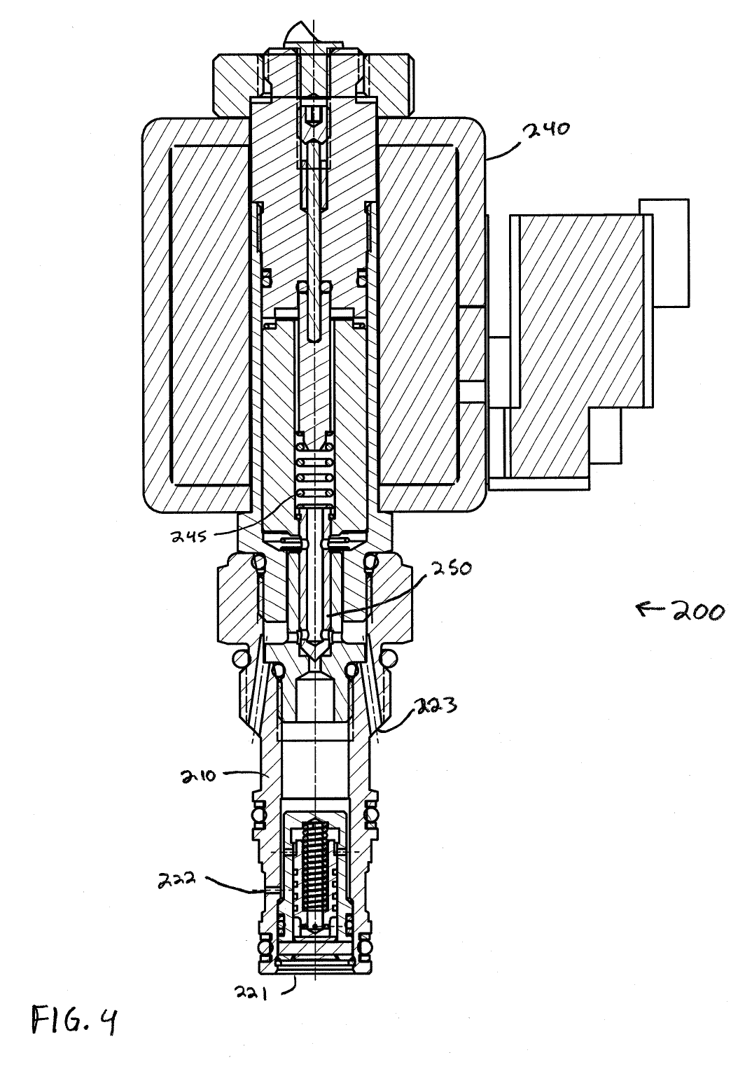

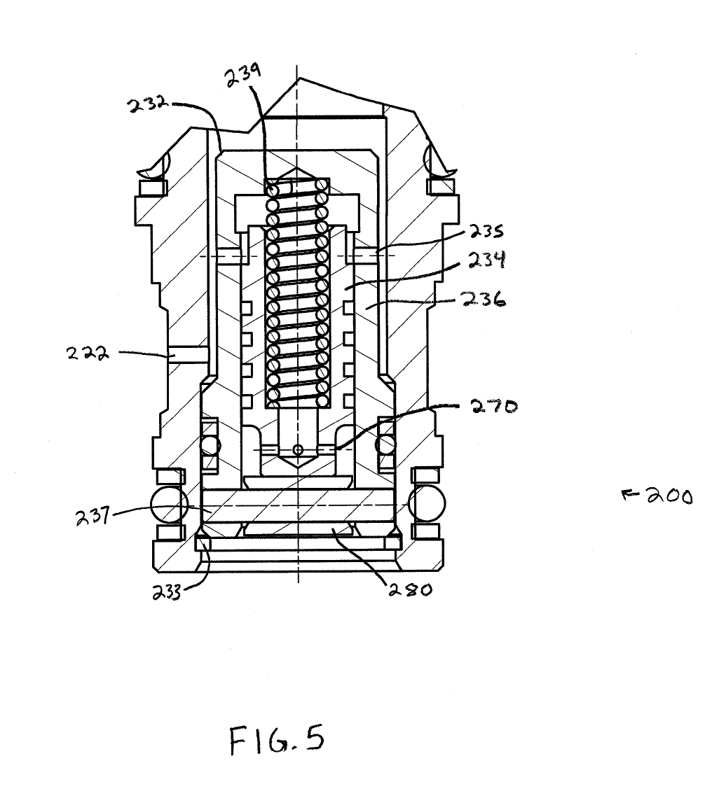

Turning now to FIGS. 4 and 5, an exemplary embodiment of the proportional pressure control valve is shown at 200. The proportional pressure control valve 200 is substantially the same as the above-referenced proportional pressure control valve 100, and consequently the same reference numerals but indexed by 100 are used to denote structures corresponding to similar structures in the proportional pressure control valve. In addition, the foregoing description of the proportional pressure control valve 100 is equally applicable to the proportional pressure control valve 200 except as noted below. Moreover, it will be appreciated upon reading and understanding the specification that aspects of the proportional pressure control valves may be substituted for one another or used in conjunction with one another where applicable.

In proportional pressure control valve 200, a stop 280 is added, held by pin 237. Stop 280 is configured to have a close tolerance with the sleeve 232 so as to provide a stationary edge filter. In this way, the edge filter of proportional pressure control valve 100 is moved from the movable piston to a stationary and separate component.

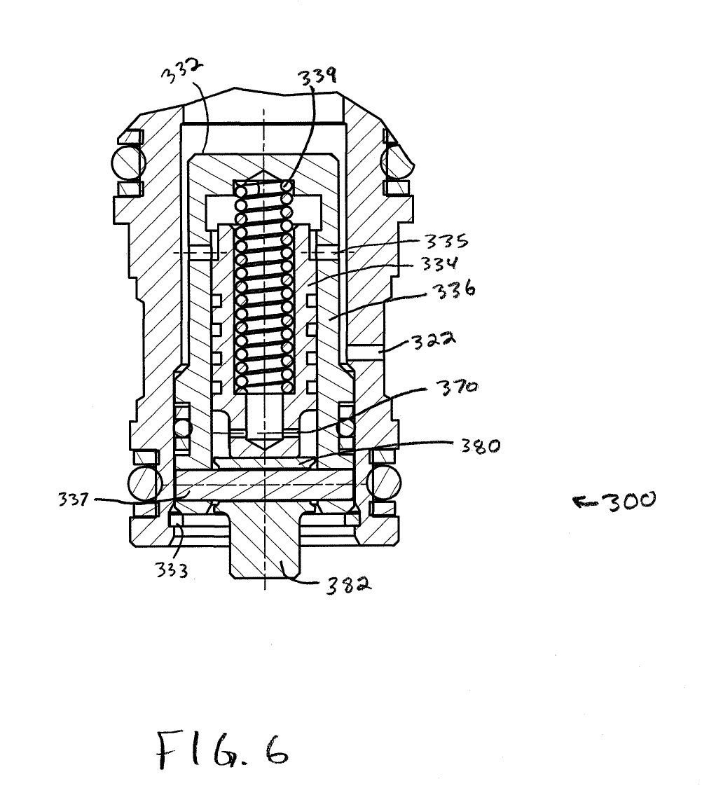

Turning now to FIG. 6, a partial view of an exemplary proportional pressure control valve 300 shows the pressure compensated flow control in detail. The proportional pressure control valve 300 is substantially the same as the above-referenced proportional pressure control valves 100 and 200, and consequently the same reference numerals but indexed by 100 are used to denote structures corresponding to similar structures in the proportional pressure control valve. In addition, the foregoing descriptions of the proportional pressure control valves 100 and 200 are equally applicable to the proportional pressure control valve 300 except as noted below. Moreover, it will be appreciated upon reading and understanding the specification that aspects of the proportional pressure control valves may be substituted for one another or used in conjunction with one another where applicable.

In proportional pressure control valve 300, the stop 380 includes a projection 382 making the valve easier to assemble.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A proportional pressure control valve, comprising:
a cage housing extending along a central axis and having an inlet, a relief outlet, and a control outlet;
a relief poppet movable between a first position and a second position, the first position restricting flow from exiting the cage housing via the relief outlet and the second position allowing flow to exit the cage housing via the relief outlet to provide a proportional relief to the valve;
a sleeve received in a central bore of the cage housing, the sleeve having a fluid inlet fluidly connected to the inlet of the cage housing and having a fluid outlet fluidly connected to the relief outlet and the control outlet of the cage housing; and
a control piston received in a central bore of the sleeve and axially moveable between first and second positions therein, the control piston configured to restrict flow through the outlet of the sleeve when the control piston is in the second position, and wherein the control piston is biased towards the first position.

2. The valve of claim 1, wherein the fluid outlet of the sleeve is in a sidewall of the sleeve.

3. The valve of claim 1, wherein the cage housing includes a sidewall having a fluid outlet therein, wherein the fluid outlet of the cage housing is fluidly connected to the fluid outlet of the sleeve.

4. The valve of claim 1, wherein the relief outlet of the valve is a plurality of slots on the outside of the cage housing.

5. The valve of claim 1, wherein the relief poppet is biased towards the first position.

6. The valve of claim 1, wherein a biasing force on the relief poppet is adjustable via a solenoid opposing a spring element providing the biasing force.

7. The valve of claim 1, wherein the control piston and the inlet of the sleeve form an edge filter.

8. The valve of claim 1, wherein the control piston further includes a central bore open at a first end to the central bore of the sleeve, and the central bore of the piston is fluidly connected to the sleeve inlet via multiple sense orifices.

9. A proportional pressure control valve, comprising:
a cage housing extending along a central axis and defining an inlet at a first end thereof for directing fluid into the cage housing;
an outlet through a plurality of slots on the outside of the cage housing providing a proportional relief to the valve;
a pressure compensating flow control valve comprising a cylindrical sleeve and a piston positioned within the first end of the cage housing, the cylindrical sleeve having an opening at one end thereof and having an orifice in a cylindrical wall of the sleeve, the piston positioned within the sleeve and biased toward the open end of the sleeve by a spring, the piston configured to selectively open and close the control holes in the sleeve; and
an orifice in the cage housing providing a fluid passageway from the outside of the cylindrical sleeve through the cage housing.

10. The valve of claim 9, wherein the piston includes an edge filter.

11. The valve of claim 9, wherein the piston includes a plurality of sense orifices.
